(19) United States
(12) Patent Application Publication
(10) Pub. No.: US 2008/0089622 A1
(43) Pub. Date: Apr. 17, 2008

(54) LINEAR GUIDE DEVICE

(76) Inventor: Alfred Haub, Luelsfeld (DE)

Correspondence Address: Striker, Striker & Stenby, 103 East Neck Road, Huntington, NY, 11743, US

(21) Appl. No.: 11/838,470

(22) Filed: Aug. 14, 2007

(30) Foreign Application Priority Data
Oct. 12, 2006 (DE) 10 2006 048 282.4

(51) Int. Cl. F16C 33/72; F16C 29/08

(52) U.S. Cl. 384/15

(57) ABSTRACT

A linear guide device includes a guide base with two lateral surfaces and a top surface covered with a cover strip, a rotor that wraps around at least a portion of the guide base, so that the rotor is supported on the guide base as it moves longitudinally along its longitudinal axis, and at least one scraper unit installed on the rotor on its end faces extending orthogonally to the longitudinal axis, wherein the scraper unit includes a main body and at least one sealing lip, which is at least partially in contact with the top surface and the lateral surfaces of the guide base. The sealing lip of the scraper unit is equipped, at least partially, with at least one reinforcing element.

### CROSS-REFERENCE TO A RELATED APPLICATION

The invention described and claimed hereinbelow is also described in German Patent Application DE 10 2006 048 282.4 filed on Oct. 12, 2006. This German Patent Application, whose subject matter is incorporated here by reference, provides the basis for a claim of priority of invention under 35 U.S.C. 119(a)-(d).

### BACKGROUND OF THE INVENTION

The present invention generally relates to linear guide devices.

More particularly, present invention is based on a linear guide device that includes a guide base with two lateral surfaces and a top surface covered with a cover band, a rotor that wraps around at least a portion of the guide base, so that the rotor is supported on the guide base as it moves longitudinally along its longitudinal axis.

At least one scraper unit is installed on the rotor on its end faces extending orthogonally to the longitudinal axis. The scraper unit includes a main body and at least one sealing lip, which is at least partially in contact with the top surface and the lateral surfaces of the guide base.

A linear guide device of this type is known, e.g., from DE 103 18 612 A1. A guide carriage supported on a guide rail in a longitudinally-movable manner is sealed in the direction toward the rail using a seal. The guide rail is provided with through-bores for fastening elements for mounting the rail on a higher-order component. The through-holes are covered with a cover strip extending across the entire axial length of the guide rail.

The free ends of the cover strip include edge regions that taper relative to the longitudinal center line of the rail, in order to make it easier, e.g., to slide the cover strip in place when the guide carriage is already located on the rail. When a guide carriage is slid onto the guide rail equipped with the cover strip, it has been shown that the sharp edges of the edge regions may damage the seal.

### SUMMARY OF THE INVENTION

The object of the present invention, therefore, is to provide a linear guide device that avoids the disadvantages of the related art and does not result in damage to the seal.

According to the present invention, the object is attained by the fact that the at least one sealing lip of the scraper unit is equipped, at least partially, with at least one reinforcing element.

A particularly simple design of a reinforcing element is the formation of a wedge-shaped rib, which causes the sealing lip to widen when the rotor or the cover strip is slid into place.

A particularly advantageous embodiment of a reinforcing element is the design of a first surface on the reinforcing element that extends essentially parallel to a lateral surface of the main body of the scraper unit and has a height that is equal to or less than the thickness of the cover strip. A second surface abuts this first surface to form an obtuse angle, which extends beyond the width of the cover strip. With this embodiment of the present invention, better protection against penetration by foreign objects in the rotor may be attained.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1: shows a perspective view of a linear guide device in accordance with the present invention,

FIG. 2: shows a perspective view of a scraper unit of the linear guide device in accordance with the present invention,

FIG. 3: shows an enlarged depiction of the detail X in FIG. 2 of the scraper unit in accordance with the present invention,

FIG. 4: shows a sectional view along line A-A in FIG. 2 of the scraper unit in accordance with the present invention, and

FIG. 5: shows a sectional view of a further embodiment, along line A-A in FIG. 2 of the scraper unit in accordance with the present invention.

### DESCRIPTION OF THE PREFERRED EMBODIMENTS

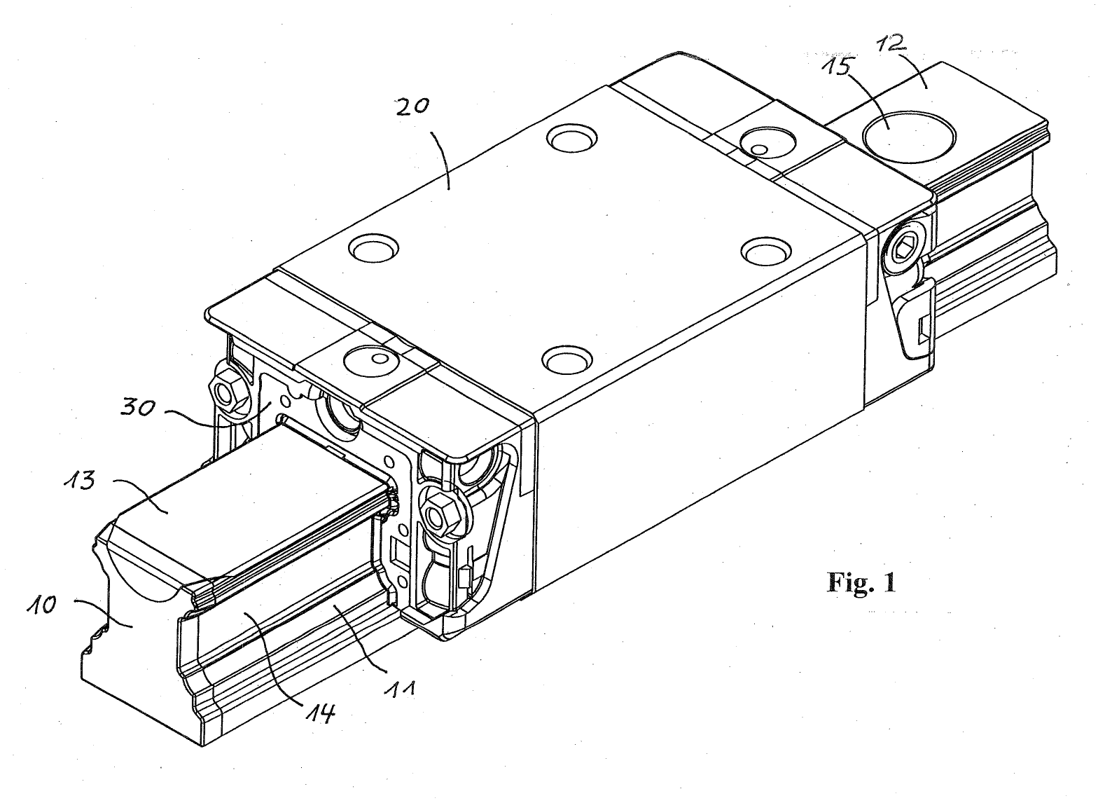

The linear guide device shown in FIG. 1 is a rail guide with a guide base 10 designed as a profiled guide rail. Guide base 10 has two lateral surfaces 14, a top surface 12, and a bottom surface, via which it is mounted on a higher-order assembly. To this end, through-bores 15 are provided in guide base 10, which extend from top surface 12 to the bottom surface and are penetrated by not-shown fastening means. Through-bores 15 are closed via a cover strip 13, which covers essentially the entire top surface and a portion of lateral surfaces 14. A smooth surface is obtained as a result, which is free of gaps and edges.

Guide base 10 is equipped with tracks 11 on its lateral surfaces for not-shown balls, via which a rotor 20—designed as a guide carriage—is supported on guide base 10 along the longitudinal axis. Rotor 20 wraps around guide base 10 in a nearly U-shaped manner and includes tracks, which are diametrically opposed to tracks 11, by way of which a carrier channel is formed. The balls in a circuit are captively accommodated in rotor 20 in the form of an endless loop. In the exemplary embodiment shown, four ball loops are provided in all, which support rotor 20 on guide base 10 in a longitudinally-movable manner.

Scraper units 30 are installed on both end faces of rotor 20, which make it impossible or difficult for dirt or coolant to penetrate rotor 20. Scraper units 30 also serve to hold lubricant such as lubricating grease or lubricating oil inside rotor 20, or at least make it difficult for the lubricant to escape.

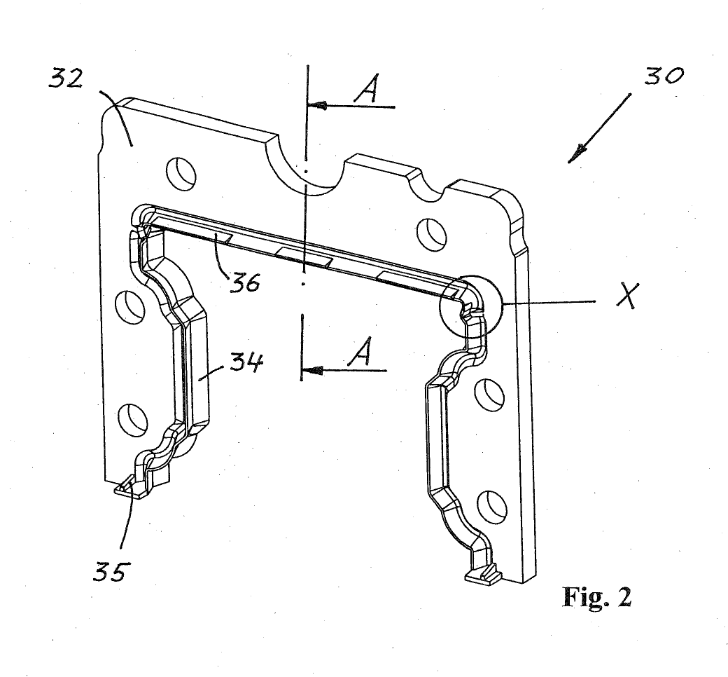

FIG. 2 shows a scraper unit 30, which has a U-shape and essentially follows the cross-sectional geometry of guide base 10. Scraper unit 30 is composed of a plate-shaped main body 32, on which two circumferential sealing lips 34 are installed. Sealing lips 34 and main body 32 are preferably injection-moulded out of the same material, e.g., plastic. It is also feasible to make sealing lips 34 out of a softer plastic, in order to improve its adaptability—in particular—to the surface of guide base 10, and therefore, to improve its sealing effect. It is also feasible to manufacture main body 32 out of metal, on which sealing lips 34 are then installed.

FIG. 2 also shows that reinforcing elements 36 are installed on sealing lips 34. In this exemplary embodiment, at total of three upper reinforcing elements 36 assigned to top surface 12 and one lateral reinforcing element 36 is assigned to each of the lateral surfaces 14 of guide base 10 are provided on each side of scraper unit 30; they are preferably made of the same material as the sealing plate, during the injection-moulding process. It is also feasible to make reinforcing elements 36 out of a harder material than sealing lips 34, to prevent wear.

A stiffening element 35, which is preferably made of the same material as sealing lip 34, is also located on each of the open ends of sealing lip 34.

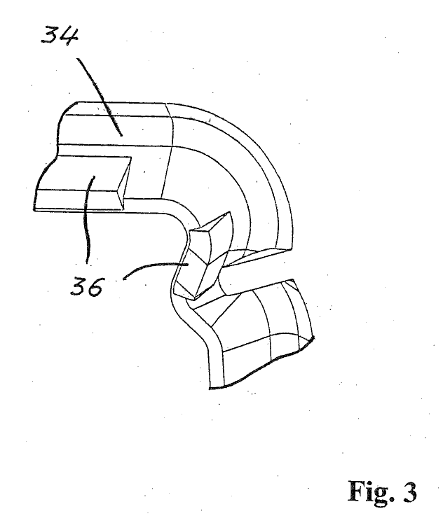

Reinforcing elements 36 assigned to lateral surfaces 14 are shown enlarged in FIG. 3, for clarity.

It is clear that lateral reinforcing elements 36 are located diametrically opposed to lateral surfaces 14, onto which the fastening sections of cover strip 13 latch behind the rearward grips of lateral surfaces 14 of guide base 10. This region is critical in terms of sealing lips 34, in particular, because this is where the tapered strip ends transition into the full width of cover strip 13.

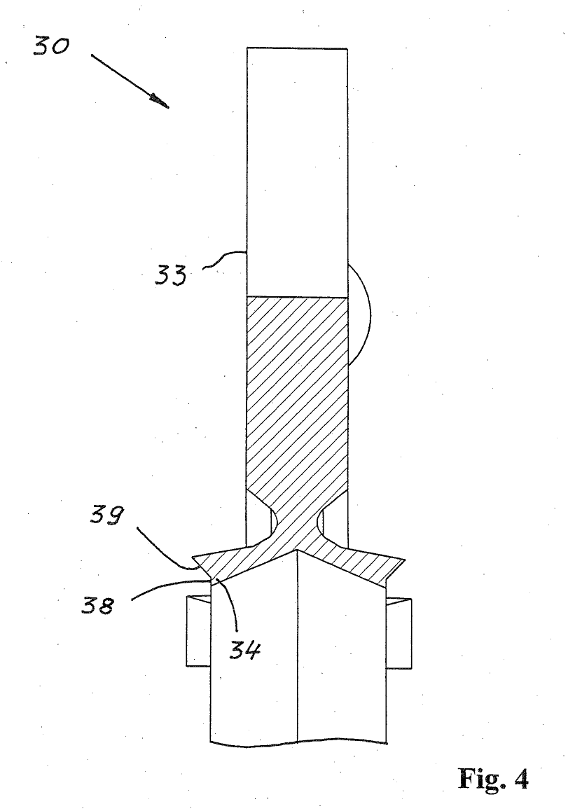

The sectional view in FIG. 4 shows the preferred geometrical relationships on sealing lips 34 and reinforcing elements 36. The height of a first surface 38, which extends essentially parallel to lateral surface 33 of scraper unit 30, is at least as great as the thickness of cover strip 13. This has the advantage that a better wiping effect is attained, which makes it much more difficult for external foreign objects to penetrate.

As shown in FIG. 4, a second surface 39 abuts first surface 38 directly; the two surfaces form an obtuse angle with each other. Second surface 39 is therefore designed as a slanted surface, against which the end of cover strip 13 comes to bear, e.g., when rotor 20 is slid onto guide base 10 with cover strip 13 in place. Since surface 39 is designed in the shape of a wedge, sealing lip 34 is lifted in the radial direction away from cover strip 13 and may glide, undamaged, on cover strip 13.

The present invention is not limited to the exemplary embodiment described above. Instead, deviations thereof are feasible, which make use of the range of protection provided by the subsequent claims.

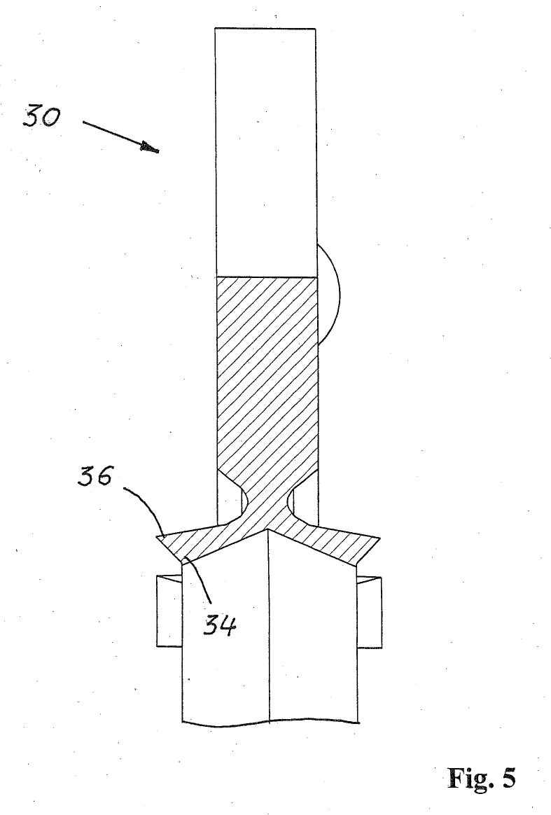

For example, reinforcing element 36 shown in FIG. 5 includes only one wedge-shaped surface 39, which extends toward sealing lip 34.

The present invention also includes the idea that sealing lip 34 located on scraper unit 30 may be designed with only one lip. Preferably, reinforcing elements 36 are then located, in pairs, diametrically opposed to sealing lip 34 on both sides.

It will be understood that each of the elements described above, or two or more together, may also find a useful application in other types of constructions differing from the type described above.

While the invention has been illustrated and described as embodied in a linear guide device, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A linear guide device, comprising a guide base having two lateral surfaces and a top surface; a cover strip covering said top surface; a rotor that wraps around at least a portion of said guide base so that said rotor is supported on said guide base as said rotor moves longitudinally along a longitudinal axis of said guide base; at least one scraper unit installed on said rotor on its end faces extending orthogonally to said longitudinal axis, said scraper unit including a main body and at least one sealing lip which is at least partially in contact with said top surface and said lateral surfaces of said guide base, said at least one sealing lip of said scraper unit being equipped, at least partially, with at least one reinforcing element.

2. A linear guide as defined in claim 1, wherein said sealing lip includes an additional reinforcing element, so as to provide two said reinforcing elements, said two reinforcing elements being diametrically opposed to each other in a pair and oriented away from each other.

3. A linear guide as defined in claim 1, wherein said reinforcing element of said sealing lip is configured as a wedge-shaped rib.

4. A linear guide as defined in claim 1, wherein said reinforcing element of said sealing lip is composed of a same material as said sealing lip.

5. A linear guide as defined in claim 1, wherein said reinforcing element has a first surface that extends at least substantially parallel to a lateral surface of said main body, which is abutted by a second surface that forms an acute angle with the lateral surface of said main body.

6. A linear guide as defined in claim 5, wherein said first surface of said reinforcing element has a height which is at most equal to a thickness of said cover strip.

7. A linear guide as defined in claim 5, wherein said second surface of said reinforcing element extends beyond a width of said cover strip.

8. A linear guide as defined in claim 1, further comprising another sealing strip so that there are two said sealing strips, said two sealing strips with said at least one reinforcing element each being located on said scraper unit.

9. A linear guide as defined in claim 1, further comprising another such reinforcing element so as to provide two reinforcing elements, said two reinforcing elements being diametrically opposed and oriented away from each other.

10. A linear guide as defined in claim 1, wherein the linear guide device is configured as an anti-friction guideway.
